(19) United States
(12) Patent Application Publication
(10) Pub. No.: US 2011/0296737 A1
(43) Pub. Date: Dec. 8, 2011

(54) Fishing Lure Cover

(76) Inventor: Michael J. Peluso, Bismarck, ND (US)

(21) Appl. No.: 13/153,414

(22) Filed: Jun. 4, 2011

Related U.S. Application Data
(60) Provisional application No. 61/351,641, filed on Jun. 4, 2010.

(51) Int. Cl. A01K 85/00

(52) U.S. Cl. 43/42.32

(57) ABSTRACT

A fishing lure cover comprising a lure cover, wherein the lure cover is planar and further wherein an underside of the lure cover has an adhesive backing and a top side of the lure cover has an optional decorative design; a base sheet removably adhered to the underside of the lure cover; and an optional top sheet removably adhered to the top side of the lure cover. An alternative embodiment is a spinner cover for a fishing spinner, wherein the spinner cover has the same characteristics as the lure cover. Yet another alternative embodiment is an eye cover for a fishing eye hook, wherein the eye cover has the same characteristics as the lure cover.

### CROSS-REFERENCE TO RELATED APPLICATION

This application claims the benefit of U.S. Provisional Application No. 61/351,641 filed Jun. 4, 2010.

### BACKGROUND OF THE INVENTION

1. Field of the Invention

The field of the present invention relates to fishing lures and, in particular, to a fishing lure cover.

2. Description of Related Art Including Information Disclosed Under 37 CFR 1.97 and 37 CFR 1.98

There is a seemingly endless variety of fishing lures used by recreational and professional fishers. Lures and other accessories used in tackle fishing are made from all different materials, including wood, metal, plastic, fiberglass and the like, and come in all shapes and sizes. Lures are constructed to attract different species of fish, as well as for optimal attraction of a desired fish species under different environmental conditions, such as air and water temperature, sunny skies, cloudy skies, rough waters, smooth waters and any other environmental variant. As a result, fishers often have an extensive tackle collection they carry with them when fishing so as to be ready for any and all environmental conditions and to attract the particular fish species for which they are fishing.

Sometimes, the lure variation a fisher may need for a particular environmental condition can be as simple as the same lure, but in a different color. Numerous examples abound of means by which a fisher can vary or modify an existing lure to attract a particular fish species, or to suit environmental conditions, rather than the fisher replacing the existing lure with a different lure specifically made for the fish species or conditions at hand. Some examples follow.

U.S. Pat. No. 3,392,474 issued Jul. 16, 1968, by Weese for Artificial Bait Apparatus discloses a cover jacket of springy material having a split or part therein to enable the cover to pass over and encase the main body of a fishing lure.

U.S. Pat. No. 3,408,764 issued Nov. 5, 1968, by McCurry for Fishing Lure discloses a fishing lure having interchangeable body side panel inserts.

U.S. Pat. No. 3,418,745 issued Dec. 31, 1968, by Loos for Fishing Lure Cover discloses a cover for a fishing lure that comprises a cover longitudinally slotted to allow the cover to be mounted in telescopic relationship over the lure and secured thereon.

U.S. Pat. No. 3,913,257 issued Oct. 21, 1975, by Colgan for Fish Lure with Exchangeable Side Panels discloses a fishing lure that comprises two body panels detachably secured to a center plate, whereby body panels of different appearances can be used to simulate the appearance of different bait fish.

U.S. Pat. No. 5,301,453 issued Apr. 12, 1994, by Terrill for Fish Lure with Interchangeable Body Section discloses a fish lure, including a rigid body and interchangeable body sleeves, telescopically attached to the rigid body, whereby a variety of bait configurations can be used on the same lure in accordance with particular fishing conditions.

U.S. Pat. No. 5,333,406 issued Aug. 2, 1994, by Wylie for Replaceable Cover for Fishing Lures discloses a fishing lure comprising a lure blank enclosed in a cover of resilient cloth with the outer surface of said cover decorated to provide a desired color and appearance for the lure.

U.S. Pat. No. 6,393,757 issued May 28, 2002, by Bomann for Flesh-Like Jacket for Fishing Lures discloses a combination fishing lure comprising a common crank bait and a removable jacket which is a highly elastic covering molded into a seamless, elongated shell that is stretchable over the crank bait.

U.S. Pat. No. 6,606,815 issued Aug. 19, 2003, by Toris for Trolling Spoon with Exchangeable Color Pattern discloses a trolling spoon comprising a frame with fasteners for hooks and a line, and a plastic cover, having a color pattern to imitate a fish, which fits on the frame.

US Patent Application 2006/0010764 published Jan. 19, 2006, by Frawley et al. for Fishing Lure Having Snap-On Cover discloses a vacuum-formed, resilient, shell cover for a lure, which cover resiliently snaps on to and over the lure.

US Patent Application 2007/0199233 published Aug. 30, 2007, by Higgin for Fishing Lure discloses a fishing lure system consisting of lure bodies of one or more parts and covered with at least one replaceable decorated plastic sleeve or cover which is attached to the lure body by adhesive means and/or shrunk by application of heat or other means to conform to the shape of the lure body.

### BRIEF SUMMARY OF THE INVENTION

A fishing lure cover for a lure comprising a lure cover, wherein the lure cover is planar and further wherein an underside of the lure cover has an adhesive backing and a top side of the lure cover has a decorative design; a base sheet removably adhered to the underside of the lure cover; and a top sheet removably adhered to the top side of the lure cover.

An alternative embodiment is a fishing lure cover for a spinner comprising a spinner cover, wherein the spinner cover is planar and further wherein an underside of the spinner cover has an adhesive backing and a top side of the spinner cover has a decorative design; a base sheet removably adhered to the underside of the spinner cover; and a top sheet removably adhered to the top side of the spinner cover.

Yet another alternative embodiment is a fishing lure cover for an eye hook comprising an eye cover, wherein the eye cover is planar and further wherein an underside of the eye cover has an adhesive backing and a top side of the eye cover has a decorative design; a base sheet removably adhered to the underside of the eye cover; and a top sheet removably adhered to the top side of the eye cover.

### BRIEF DESCRIPTION OF THE SEVERAL VIEWS OF THE DRAWINGS

FIG. 1 is a perspective view of a crank bait lure with a lure cover.

FIG. 2 is a perspective view of a lure cover being applied to a crank bait lure.

FIG. 3 is a top plan view of a sheet having thereon lure covers, spinner covers and eye hook covers.

FIG. 4. is a perspective view of an eye hook with an eye hook cover.

FIG. 5 is a perspective view of a spinner with a spinner cover.

FIG. 6 is a perspective view of a lure cover being removed from a sheet having thereon lure covers, spinner covers and eye hook covers.

### LIST OF REFERENCE NUMERALS

2 lure
4 lure body
6 split ring anchor
8 split ring
10 bill
12 hook
14 lure cover
16 anchor recess
18 bill recess
20 spinner
22 spinner cover
24 spinner cover hole
26 eye hook
28 eye cover
30 base sheet
32 top sheet
34 sheet with covers
36 adhesive surface

### DETAILED DESCRIPTION OF THE INVENTION

A fishing lure cover of the present invention may be used in conjunction with various tackle components or articles, such as lures, spinners, eye hooks, crank baits, spoons, jigs, blades and the like. A ‘crank bait’ is defined herein as a hard-bodied fishing lure that naturally produces action when retrieved, namely, what fishers refer to as a ‘swimming wiggle’ when the crank bait is pulled through the water as a fishing line to which the crank bait is attached is reeled in and on to a reel. A crank bait may or may not have an integral bill.

The term ‘lure’ as used herein encompasses any tackle component or article capable of having a fishing lure cover of the present invention applied to it, including but not limited to, the aforementioned lures, spinners, eye hooks, crank baits, spoons, jigs, blades and the like. Likewise, it is understood that reference herein to the fishing lure cover of the present invention includes not only a lure cover for a fishing lure, such as a lure, crank bait, spoon, jig, blade and the like, but also a spinner cover for a spinner and an eye cover for an eye hook. These lure cover, spinner cover and eye cover embodiments are further disclosed herein.

The fishing lure cover of the present invention comprises a lure cover, wherein the lure cover is substantially planar and two-dimensional, or flat, and further wherein an underside of the lure cover has an adhesive backing and a top side of the lure cover has an optional decorative design. A base sheet is removably adhered to the underside of the lure cover and an optional top sheet is removably adhered to the top side of the lure cover. The adhesive backing may be made of any suitable adhesive substance that enables the lure cover to be, at a user's preference, either permanently, semi-permanently, or removably attached, to a component or article of tackle such as a lure, spinner, eye hook, crank bait, spoon, jig, blade or the like.

The fishing lure cover of the present invention preferably is made of vinyl. The fishing lure cover alternatively may be made of any suitable material capable of accepting an adhesive backing, such as paper, wood veneer, plastic, fabric, or any other suitable material.

The fishing lure cover may be constructed in any size or shape suitable to a user's particular tackle component need. The fishing lure cover may have an optional decorative design thereon which may comprise any color scheme or graphic design desired by a user to suit the user's tackle need. The decorative design may be any design of a user's preference, such as a solid color, variegated color, multiple color scheme, or graphic design, whether or not it mimics or is representative of a particular fish species, insect species, or other desirable fish, insect, bait or environmental characteristics to attract fish.

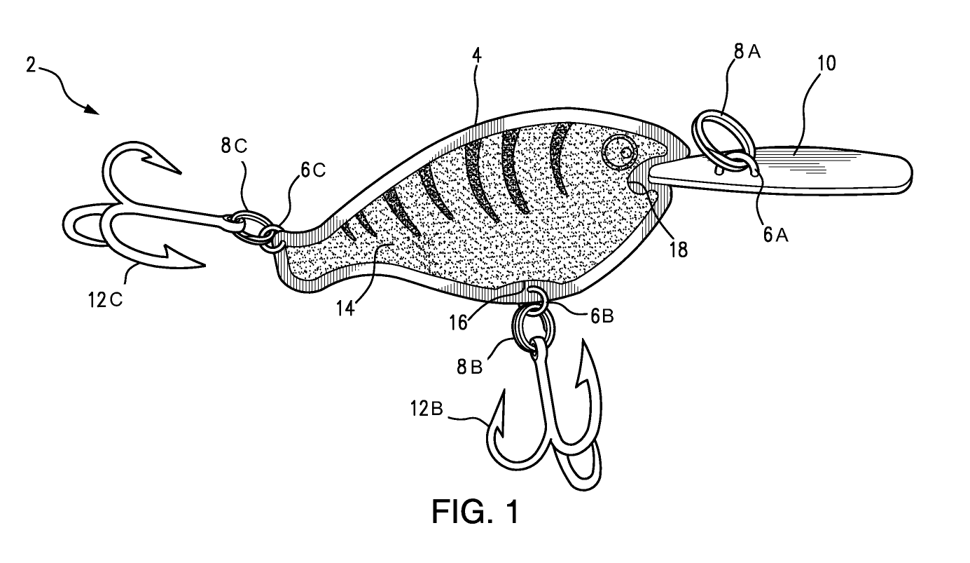

An embodiment of the fishing lure cover of the present invention is shown in FIG. 1. A lure 2 of the crank bait type is shown wherein a lure body 4 is covered with a lure cover 14 of the present invention. Typically, a lure body 4 has two large surface area sides to it, a left-hand or sinistral side and a right-hand or dextral side. A lure cover 14 of the present invention preferably is applied to each of a sinistral side and a dextral side of the lure 2. The lure cover 14 also may be applied to each of a ventral surface and a dorsal surface of a lure body 4. However, the ventral and dorsal surfaces usually comprise lesser surface areas of the lure body 4 and, therefore, typically are not, but may be, covered with a lure cover 14.

Also with reference to FIG. 1, the lure body 4 may have additional features integral therewith such as a bill 10 on which an anterior split ring 8A is attached thereto by means of an anterior split ring anchor 6A. A fisher may use the anterior split ring 8A to attach a tackle accessory component or article, such as a spinner, or to attach a fishing line to the lure 2.

Also with reference to FIG. 1, the lure body 4 may additionally comprise a ventral split ring 8B secured by a ventral split ring anchor 6B to a ventral surface of the lure body 4. A fisher may use the ventral split ring 8B to attach a tackle accessory component or article such as a hook 12B or spinner to the lure 2.

Also with reference to FIG. 1, the lure body 4 may additionally comprise a posterior split ring 8C secured by a posterior split ring anchor 6C to a posterior surface of the lure body 4. A fisher may use the posterior split ring 8C to attach a tackle accessory component or article such as a hook 12C or spinner to the lure 2.

Also with reference to FIG. 1, the lure cover 14 may optionally have an anchor recess 16 to accommodate a ventral split ring anchor 6B. The lure cover 14 may optionally have a bill recess 18 to accommodate the bill 10 that projects from an anterior surface of the lure body 4. As shown in FIG. 1, the lure cover 14 may, but need not, have a decorative design thereon.

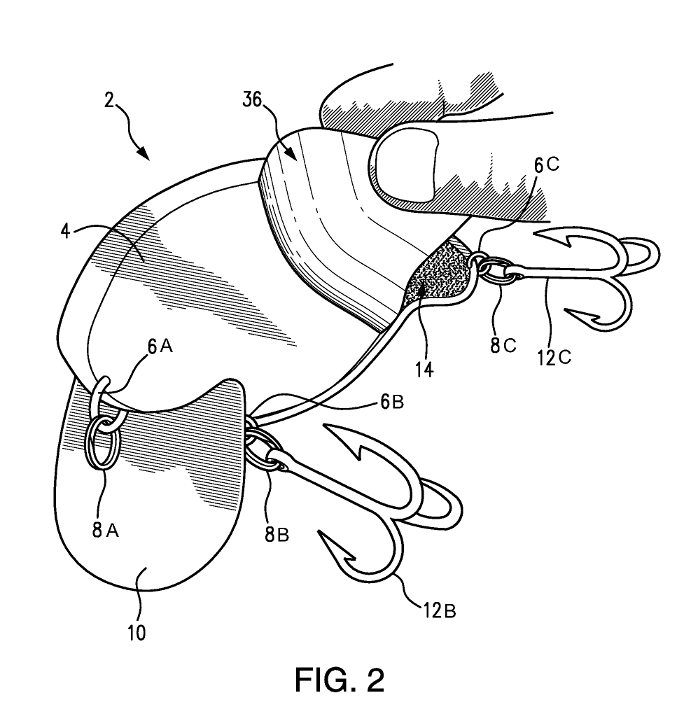

The lure cover 14 has many advantages over other prior art lure covers. As shown in FIG. 2, to use the lure cover 14 of the present invention, an adhesive surface 36 of the lure cover 14, is placed against and adhered to the lure body 4. The lure cover 14 is easily adhered to a lure body 4 without the user having to remove the lure 2 from a fishing line. Furthermore, the user does not have to take hooks 12 on and off the lure body 4 in order to put on and take off the lure cover 14. As a result, in contrast to prior art covers, the lure cover 14 of the present invention does not have to have a hole or a slit in it to fit over or to accommodate hooks 12.

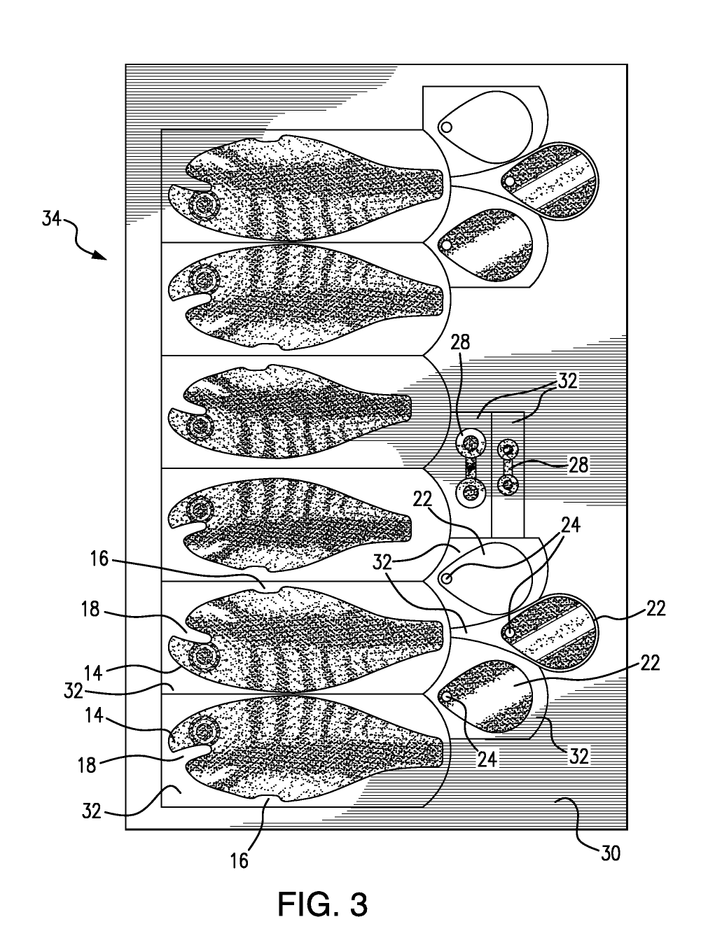

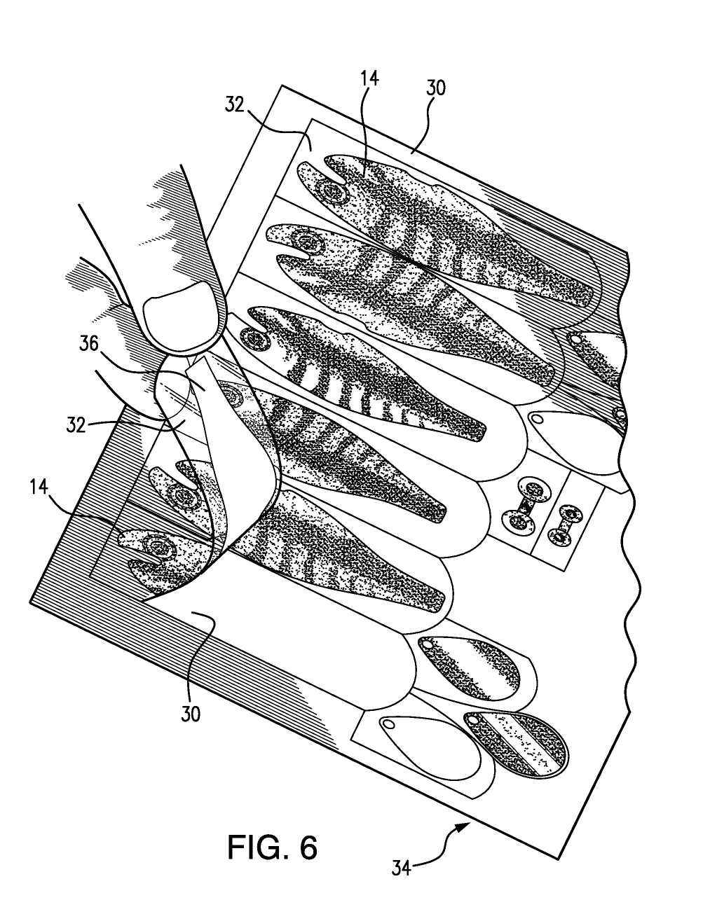

With reference to FIG. 3 and FIG. 6, the lure cover 14 of the present invention may be in conjunction with multiple lure covers 14 placed on a sheet of covers 34. A base sheet 30 has a surface that is capable of removably receiving lure covers 14 thereon such that the adhesive surface 36 of the lure cover 14 does not permanently adhere to the base sheet 30. An optional, but preferred, top sheet 32 is placed over the lure covers 14 to protect the lure covers 14 until the lure covers are ready for use. The top sheet 32 also provides a means by which a user can align and place a lure cover 14 on a lure body 4 without touching, and possibly contaminating or damaging, the adhesive surface 36 of the lure cover 14.

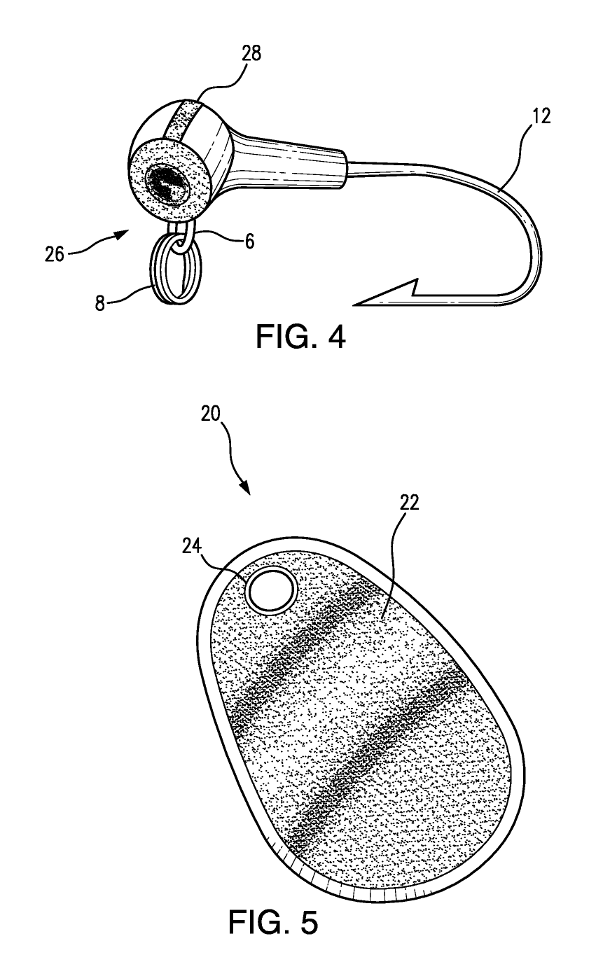

With reference to FIG. 4, in an alternative embodiment of the fishing lure cover of the present invention, an eye hook 26 having a hook 12 and a split ring anchor 6 with a split ring 8 attached thereto, may be modified with an eye cover 28 in the same fashion that a lure 2 may be modified with a lure cover 14. As shown in FIG. 4, the eye cover 28 may, but need not, have a decorative design thereon.

Likewise, in another alternative embodiment of the fishing lure cover of the present invention, as shown in FIG. 5, a spinner 20 may be modified with a spinner cover 22. The spinner cover 22 has a spinner hole 24 therein to accommodate a corresponding hole in a spinner 20. The spinner hole 24 provides a means by which a spinner 20 may be fastened to another component or article of tackle, such as a lure 2. As shown in FIG. 5, the spinner cover 22 may, but need not, have a decorative design thereon.

Again with reference to FIG. 3 and FIG. 6, likewise, multiple spinner covers 22 and multiple eye covers 28 may be placed on a sheet of covers 34. The base sheet 30 has a surface that is capable of removably receiving spinner covers 22 and/or eye covers 28 thereon such that an adhesive surface of the spinner cover 22 or the eye cover 28 does not permanently adhere to the base sheet 30. An optional, but preferred, top sheet 32 is placed over the spinner covers 22 and eye covers 28 to protect the covers until the covers are ready for use. The top sheet 32 also provides a means by which a user can align and place a spinner cover 22 on a spinner 20, or an eye cover 28 on an eye hook 26, without touching, and possibly contaminating or damaging, the adhesive surface of the spinner cover 22 or eye cover 28.

With reference to FIG. 6, to use a lure cover 14 of the present invention, a user removes the lure cover 14 from the base sheet 30 by means of the optional top sheet 32 while leaving the top sheet in contact with the lure cover 14. The top sheet 32 is removably adhered to the lure cover 14. After removal of the lure cover 14 from the base sheet 30, the adhesive surface 36 is placed in contact with and adhered to the lure body 4 as shown in FIG. 2. Once the lure cover 14 is adhered to the lure body 4, then the user removes the top sheet 32 from the lure cover 14. Alternatively, to use a lure cover 14 of the present invention, a user removes the lure cover 14 from the base sheet 30 and after removal of the lure cover 14 from the base sheet 30, the adhesive surface 36 is placed in contact with and adhered to the lure body 4 as shown in FIG. 2.

As also shown in FIG. 6, an eye cover 28 is adhered to the base sheet 30 and protected by an optional, but preferred, top sheet 32; and a spinner cover 22 is adhered to the base sheet 30 and protected by an optional, but preferred, top sheet 32. The same manner of application as described herein with regard to a lure cover 14 is used to adhere a spinner cover 22 to a spinner 20 and to adhere an eye cover 28 to an eye hook 26.

The lure cover 14, eye cover 28 and spinner cover 22 are removably adhered to a base sheet 30. As shown in FIG. 3 and FIG. 6, a mix of multiple lure covers 14, eye covers 28 and spinner covers 22 may, but need not, be placed on the same base sheet 30. Alternatively, a base sheet 30 may contain only lure covers 14, or only eye covers 28, or only spinner covers 22, or any combination thereof. An optional, but preferred, top sheet 32 is removably placed over the lure cover 14, eye cover 28 or spinner cover 22 to protect the covers prior to use and to enable removal of a cover from the base sheet 30 and placement of the cover on to a lure body 4, eye hook 26 or spinner 20 as applicable. Once a cover is placed on a lure body 4, eye hook 26 or spinner 20 as applicable, the top sheet 32 is removed from the cover.

A further advantage of the lure cover 14, spinner cover 22 and eye cover 28 of the present invention is that the lure cover 14, spinner cover 22 and eye cover 28 may be, but do not have to be, a shape specific to a particular lure body 4, spinner 20 or eye hook 26, respectively. The lure cover 14, spinner cover 22 and eye cover 28 may be adhered to any lure body 4, spinner 20 or eye hook 26, respectively, with sufficient surface area to accommodate the lure cover 14, spinner cover 22 or eye cover 28.

Other advantages of the lure cover 14, spinner cover 22 and eye cover 28 of the present invention over prior art covers are that the lure cover 14, spinner cover 22 and eye cover 28 do not have multiple parts to put together prior to attachment to a lure body 4, spinner 20 or eye hook 26, respectively, and that the lure cover 14, spinner cover 22 or eye cover 28 do not have any fasteners.

Another advantage of the lure cover 14, spinner cover 22 and eye cover 28 of the present invention is that the covers, preferably, are comprised of vinyl and, therefore, are extremely durable and can withstand extensive use and repeated fish strikes on the lure 2, spinner 20 or eye hook 26. However, once a cover has sufficiently deteriorated from use, then the cover may, but need not, be removed from the corresponding lure body 4, spinner 20 or eye hook 26 and a new cover placed either over an existing cover, or over the re-exposed surface of the lure body 4, spinner 20 or eye hook 26 after the prior cover has been removed.

Yet another advantage of the lure cover 14, spinner cover 22 and eye cover 28 of the present invention is that the covers are small, lightweight, compact and take up very little room in and add very little weight to a tackle box.

Yet another advantage of the lure cover 14, spinner cover 22 and eye cover 28 of the present invention is that use of the covers does not require advance planning, preparation, or application by a user, but rather may be applied by a user as needed at any time, even in the midst of a fishing excursion, to a lure 2, spinner 20 or eye hook 26.

Unless defined otherwise, all industry, technical and scientific terms used herein have the same meaning as commonly understood by one of ordinary skill in the art to which this invention belongs. Although any methods and materials similar or equivalent to those described herein also may be used in the practice or testing of the present invention, the preferred methods and materials are described.

The present invention is disclosed with reference to specific embodiments; however, it is understood that modifications and variations of the present invention are possible without departing from the scope of the invention, which is defined by the claims set forth below.

The invention claimed is:

1. A fishing lure cover comprising:
a. A lure cover, wherein the lure cover is planar and further wherein an underside of the lure cover has an adhesive backing; and
b. A base sheet removably adhered to the underside of the lure cover.

2. The fishing lure cover of claim 1 further comprising a top sheet removably adhered to the top side of the lure cover.

3. The fishing lure cover of claim 1 further wherein the top side of the lure cover has a decorative design.

4. A fishing lure cover comprising:
a. A lure cover, wherein the lure cover is planar and further wherein an underside of the lure cover has an adhesive backing and a top side of the lure cover has a decorative design;
b. A base sheet removably adhered to the underside of the lure cover; and
c. A top sheet removably adhered to the top side of the lure cover.

5. A fishing spinner cover comprising:
a. A spinner cover, wherein the spinner cover is planar and further wherein an underside of the spinner cover has an adhesive backing; and
b. A base sheet removably adhered to the underside of the spinner cover.

6. The fishing spinner cover of claim 5 further comprising a top sheet removably adhered to the top side of the spinner cover.

7. The fishing spinner cover of claim 5 further wherein the top side of the spinner cover has a decorative design.

8. A fishing spinner cover comprising:
a. A spinner cover, wherein the spinner cover is planar and further wherein an underside of the spinner cover has an adhesive backing and a top side of the spinner cover has a decorative design;
b. A base sheet removably adhered to the underside of the spinner cover; and
c. A top sheet removably adhered to the top side of the spinner cover.

9. A fishing eye cover comprising:
c. An eye cover, wherein the eye cover is planar and further wherein an underside of the eye cover has an adhesive backing; and
d. A base sheet removably adhered to the underside of the eye cover.

10. The fishing eye cover of claim 9 further comprising a top sheet removably adhered to the top side of the eye cover.

11. The fishing eye cover of claim 9 further wherein the top side of the eye cover has a decorative design.

12. A fishing eye cover comprising:
a. An eye cover, wherein the eye cover is planar and further wherein an underside of the eye cover has an adhesive backing and a top side of the eye cover has a decorative design;
b. A base sheet removably adhered to the underside of the eye cover; and
c. A top sheet removably adhered to the top side of the eye cover.
